(19) United States
(12) Patent Application Publication
(10) Pub. No.: US 2012/0242828 A1
(43) Pub. Date: Sep. 27, 2012

(54) METHOD AND APPARATUS FOR ALIGNING A COMPONENT WITH A TARGET

(75) Inventor: Bill H. Franklin, Ottawa, IL (US)

(73) Assignee: LMK ENTERPRISES, INC., Ottawa, IL (US)

(21) Appl. No.: 13/070,779

(22) Filed: Mar. 24, 2011

(51) Int. Cl. H04N 7/18

(52) U.S. Cl. 348/95; 348/E07.085

(57) ABSTRACT

Alignment systems and more particularly, to a split-screen camera system where multiple camera views are incorporated into a single composite image to align a component orthogonally to a target are provided. At least a first and second imaging device is used in conjunction with a processing unit adapted to extract or delete portions of at least a first image and a second image captured by the first and second imaging devices. The processor mirrors one of the images and creates a composite image of the first image and the second image as a split-screen image. The resulting processed image is displayed on a display terminal, and an operator aligns a component with a target.

### FIELD OF THE INVENTION

The invention relates to alignment systems and more particularly to a split-screen system where multiple camera views are incorporated into a single composite image to align a component orthogonally to a target.

### BACKGROUND OF THE INVENTION

In many industries, including the manufacturing, cured-in-place pipelining, and durable equipment industries in particular, it is often necessary to align a component in a precise predetermined position to a target surface or opening. If precise alignment is not achieved, a necessary contact may not be affected and the system may be ineffective, damaged or otherwise impaired.

There have been many prior systems designed to assure the correct positioning of a component with a target. For example, U.S. Pat. No. 4,914,513 to Spigarelli, et al (hereinafter “Spigarelli”) discusses prior art systems that place a reference point on a work surface adjacent the location on which the component is to be deposited. The system, either manually or automatically, moves the work surface until the reference point is aligned with a detecting means. The system then places the component on the surface and it is presumed that the reference point is correctly aligned. Alignment is automatic rather than visual and no viewing means to verify correct alignment is provided. Consequently, if lack of alignment occurs, through mechanical error, malfunction or otherwise, an imperfect end product results.

Spigarelli further discloses a system where an operator is provided with a clear, close up view of a work area, allowing the operator to accurately position electrical components on a target work surface. Images of different sectors of the work area are received by a viewing device such as a video camera, are processed and electronically transferred to the operator's display terminal and displayed simultaneously. By viewing the display terminal, the operator is able to observe simultaneously the critical sectors of the work area while manipulating the component with a pick-and-place head to accurately align and place the component in a pre-determined position. Such systems generally work well for targets that exist under controlled conditions, such as work stations. However, the applicability of this camera positioning system is unknown for systems and targets outside of an immobile work station.

There have been other systems that generally utilize camera technologies for the purposes of alignment or targeting. For instance, U.S. Pat. No. 5,305,099 to Morcos, et al discloses a system where optical means arranged to compare the lateral positions of a conveyor belt at two locations along its path are projected onto a split-screen and compared for correct alignment. A camera is arranged at each location to pick up an image of the conveyor belt in a frame wider than the entire width of the conveyor belt so that both edges are included. The cameras transmit video signals to a single display monitor to reproduce the images in juxtaposition to each other for comparison of the lateral positions of the web edge. The video signals can also be transmitted to an electronic circuit for electronic comparison to produce an alarm or steering roller control signal. The invention provides continuous, real-time monitoring and allows the juxtaposition of two images for easy visual detection, by an operator, of minute shifts in the conveyor belt edge(s). However, this camera system does not provide for alignment in multiple directions, as the system is only capable of determining the alignment of a conveyor belt at one point as compared to another point along one axis in the field of view.

Another camera system for aligning a component with a target is U.S. Pat. No. 7,405,388 to Reilley. Reilley discloses a center scope for a machining apparatus. The invention acts as a center scope and edge finder for a quill by processing images from two cameras that are shot from off axis vantage points. The two images are processed to create a synthetic image that appears to be shot from the on axis vantage point. The processor adds a cross-hair target designator to the image to indicate that point on the workpiece that is exactly at the center axis of the quill. However, this system requires the use of calibration steps to create the target designator. Additionally, this system creates a synthetic composite image that does not utilize the advantages of a split-screen for alignment.

In light of the aforementioned problems with known methods of aligning a component with a target, there is a need for a new method and apparatus for aligning a component with a target by providing a visual layout to an operator utilizing a split-screen alignment system capable of alignment in multiple directions which is flexible for multiple uses or scenarios.

### BRIEF SUMMARY OF THE INVENTION

It is therefore a principal object, aspect, feature or advantage of the present invention to provide an apparatus and method of viewing a target to allow accurate placement of a component relative to the target. The present invention provides enhanced viewing of and alignment with the target by using cameras to afford an operator or machine vision system views that are easily compared and aligned. The present invention permits the viewer to visually align the component orthogonally to a target.

Other objects, features, aspects, and/or advantages of the present invention relate to an apparatus that provides a split-screen view of a target where movement of the apparatus allows an operator to provide a single view of the target, aligning the apparatus with the target.

Further objects, features, aspects, and/or advantages of the present invention relate to a method of aligning a component with a target where at least two cameras are positioned such that the component to be aligned is orthogonal to the center of the intersection of the cameras' image planes

Still further objects, features, aspects, and/or advantages of the present invention relate to a method of aligning a component with a target where two images taken from different vantage points are processed so that half of each image is deleted or extracted, one of the images is mirrored, and the images are juxtaposed on a single display screen.

These and other objects, features, aspects, and/or advantages of the present invention will become apparent with reference to the accompanying specification and claims.

In one embodiment, the component is associated with a housing or other member. The component may be placed on the member precisely between two imaging devices, for example cameras, mounted on the housing. The cameras are positioned such that the component to be aligned is orthogonal to the center of the intersection of the cameras' image planes. The cameras are linked to a processing unit. The processing unit processes the signals received from the cameras, such that each of the images are halved, one of the images is then mirrored, and the resulting images are reassembled to be shown on a single display screen as a dual image. The images are split and combined so as to afford the operator simultaneous views of the target. The processing unit is connected to an operator's display screen or terminal on which the operator observes a split-screen dual image of the target. The operator is thereby permitted to manipulate the component, to achieve the exact orthogonal alignment of the component to the target.

The present invention as disclosed herein provides numerous advantages. For example, this system allows for accurate and precise positioning of a component where the direct view from the component to the target is blocked or otherwise unavailable. Additionally, this system allows for the alignment of a component with a target of unknown specifications. Provided that the target can fit into the field of view of the cameras, the target may have virtually any size or shape. Furthermore, the simple construction of the apparatus allows for use with many different systems.

Although various objects, features, aspects, or advantages are discussed herein, no single embodiment need necessarily exhibit any or all of these objects, features, or advantages.

### BRIEF DESCRIPTION OF THE DRAWINGS

FIG. 1 is a perspective view of one embodiment of the apparatus of this invention where two imaging devices are disposed on a housing having a component and the imaging devices are aligned such that the component to be aligned is orthogonal to the centers of the imaging devices' image planes.

FIG. 2 is a perspective view similar to FIG. 1 where a target is shown in the field of view of the imaging devices.

FIG. 3 is a diagram showing the imaging devices connected to a display, which is used to control the position and alignment of the component according to the present invention.

FIG. 4 is a block diagram showing an electrical configuration of the present invention.

FIG. 5a is a perspective view of a display terminal where the component is not aligned with the target along a first axis.

FIG. 5b is a perspective view of the display terminal where the component is aligned with the target along a first axis, but not aligned with the target along a second axis.

FIG. 5c is a perspective view of the display terminal where the target is fully aligned with the component along two axes.

### DETAILED DESCRIPTION OF THE PREFERRED EMBODIMENT

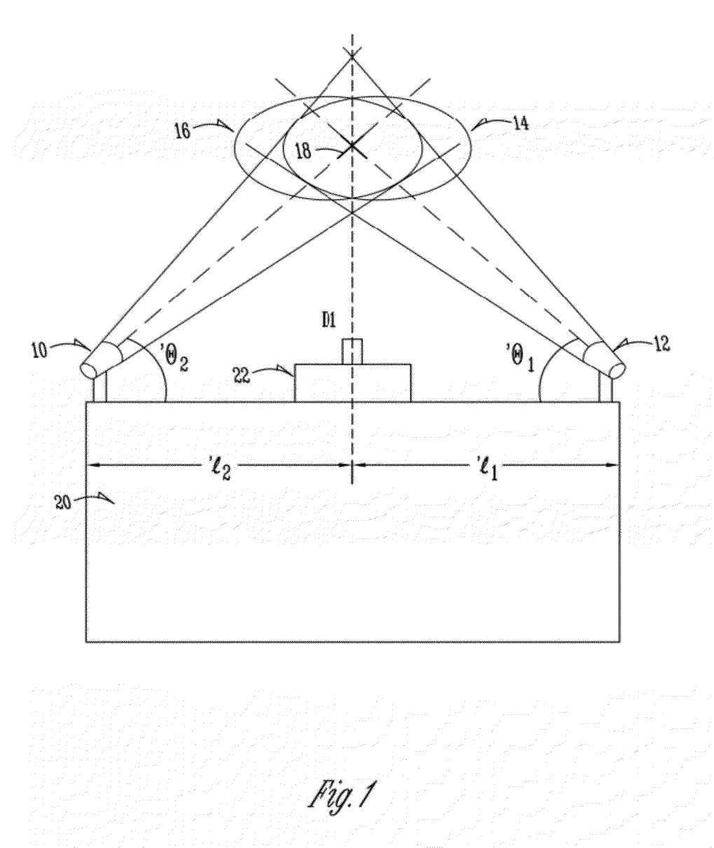

Referring now to the drawing wherein like numerals refer to like parts, FIG. 1 shows a perspective view of one embodiment of the apparatus of this invention where a first imaging device 10 and a second imaging device 12 having a first image plane 14 and a second image plane 16 are disposed on a housing 20 having a component 22. The imaging devices 10, 12 are aligned such that the component 16 to be aligned is orthogonal to the center 18 of the image planes 14, 16. As such, the imaging devices 10, 12 and the component 22 should be aligned in a linear manner. The imaging devices 10, 12 may be placed at opposite ends of the housing 20, as shown in FIG. 1. However, it should be noted that better views of the target will be achieved by placing the imaging devices 10, 12 as close to the component 22 as possible. However, for many applications, it is anticipated that the views closest to the component 22 will be blocked or otherwise unavailable.

Imaging devices 10, 12 may be standard cameras that display photographs and pictures, video cameras, or any other imaging device capable of providing an image to a user. In a preferred embodiment, video cameras are used so that a user may perform the alignment of the component to the target in real time. Imaging devices may be analog or digital imaging devices. It should be appreciated that the imaging devices 10, 12 are angularly adjustable to provide the desired angle of view. As such, the angles between the imaging devices 10, 12 are labeled θ₁ and θ₂. In a preferred embodiment, the angles θ₁ and θ₂ are equivalent. In such an embodiment, aligning the component 22 with a target is fairly simple, as the component may be placed near the center of the housing 20, such that lengths l₁ and l₂ are equivalent. It should be noted that when angles θ₁ and θ₂ are non-equivalent, the final images will be proportionally incongruent. Therefore, additional image processing may be required to provide a user with proportional images on a user display terminal. In such a system, the length or distance from the component to the target is an important aspect to achieving the correct alignment.

The component 22 will have a distance D1 from the component to the center 18 of the image planes 14, 16. Distance D1 will vary between applications. If the distance from the component 22 to a target is known, then the imaging devices 10, 12 may be adjusted such that the center 18 of image planes 14, 16 is situated at distance D1 from the component 22. If D1 is unknown, the apparatus should be manipulated until the target is visible within the field of view of the imaging devices 10, 12.

The term “housing” is simply used to illustrate the fact that the imaging devices 10, 12 are mounted in relation to the component 22. The housing 20 could be a member that holds the component. Alternatively, the housing 20 may be a portion of the component to be aligned. The component 22 is illustrated in the figures as a non-descript shape. It should be appreciated that component 22 may be anything that requires alignment with a target. For instance, the component 22 may be a pipe liner meant to provide a lining to a pipe lateral to a main pipe within a sewer. In fact, this invention was developed in conjunction with a project relating to U.S. patent application Ser. No. 12/832,633, which is hereby incorporated by reference in its entirety. Alternatively, component 22 may be the fork of a forklift. It is envisioned that the component 22 may be any member that requires alignment with a target.

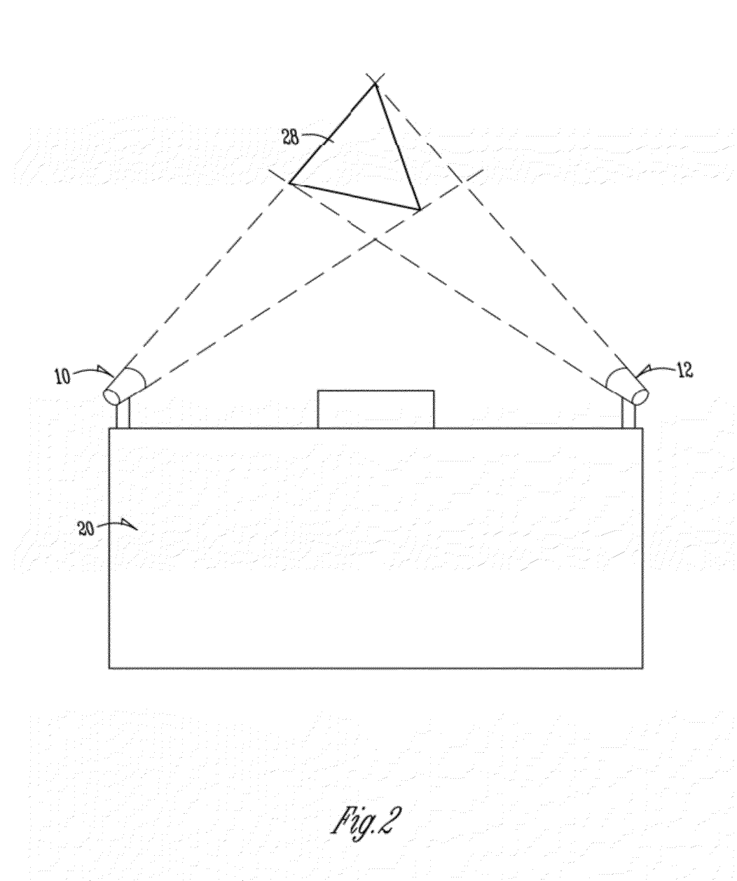

FIG. 2 illustrates where a target 24 is shown within the fields of view of the imaging devices 10, 12. The target 24 is drawn as a triangle to illustrate the method of alignment in reference to the subsequent Figures. However, it should be appreciated that target 24 may be anything that requires alignment with the component 22. For instance, the target 24 may be a pipe lateral to a main pipe within a sewer. Alternatively, target 24 may be an opening on a shipping pallet. It is envisioned that the target 24 may be any member that requires alignment with a component.

In operation, the apparatus works as follows. Two imaging devices, for example cameras, are placed in relation to a component. The cameras are positioned such that the component to be aligned is orthogonal to the center of the intersection of the cameras' image planes. The cameras are linked to a processing unit. The processing unit processes the signals received from the cameras, such that each of the images are halved, one of the images is then mirrored, and the resulting images are reassembled to be shown on a single display screen as a dual image. The images are split and combined so as to afford the operator simultaneous views of the target. The processing unit is connected to an operator's display terminal on which the operator observes a split-screen dual image of the target. The apparatus is placed in relation to the target such that the target appears on the screen. The operator is thereby permitted to manipulate the component, to achieve the exact orthogonal alignment of the component to the target by aligning the images on the screen. Aligning the images on the split-screen will allow for alignment along a single axis. The split-screen display may include a scale that shows the width of the images. When the width of the target is shown equally across the screens, the target has been aligned with respect to a second axis. The component may optionally be moved along a third axis, shown in FIG. 1 as distance D1, to come in contact with the target.

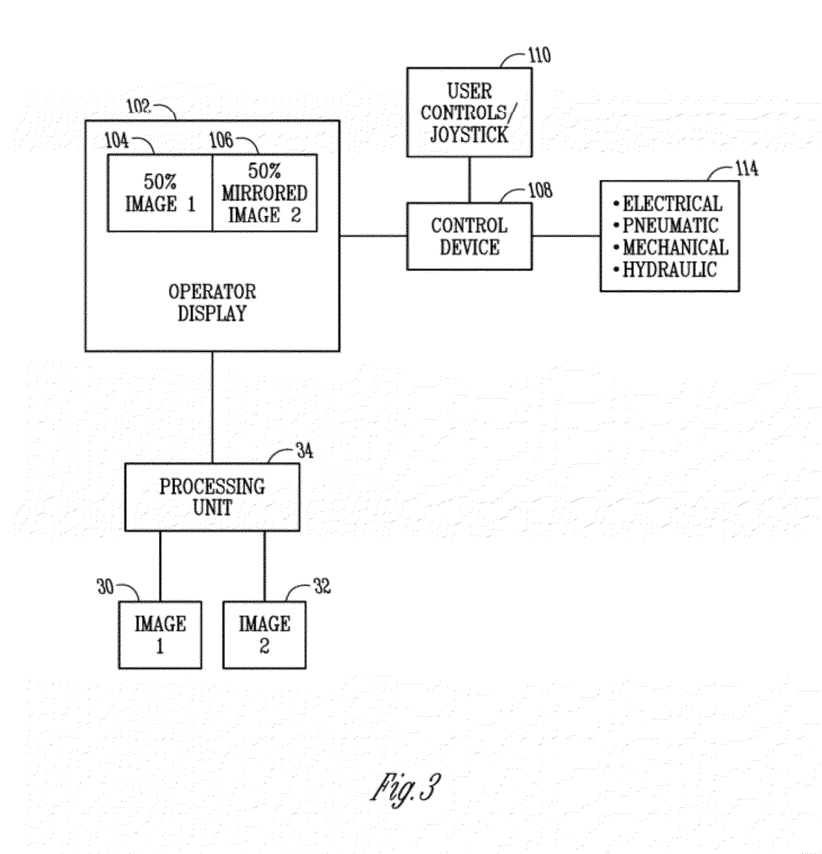

FIG. 3 is a diagram showing the imaging devices 10, 12 connected to a display terminal or operator display 102, which is used to control the position and alignment of the component 22. The operator display 102 may be a television, a computer monitor, a screen, an LCD display, or any other part capable of receiving a signal and displaying an output. In addition, the imaging devices 10, 12 may be connected to the operator display 102 by wires, or they may be wirelessly connected.

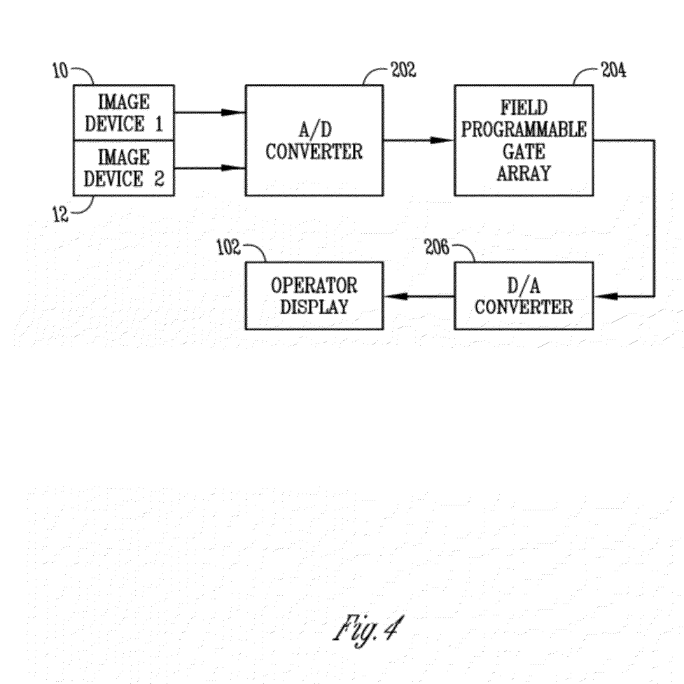

The imaging devices 10, 12 capture image one 30 and image two 32. The images 30, 32 are sent to a processing unit 34. The processing unit will generally include processors to execute certain functions that process the image data. An example block diagram of an electrical configuration is shown in FIG. 4. As illustrated in the example, if the imaging devices 10, 12 are cameras that produce analog data, the processing device will include an analog-to-digital converter 202. Once the analog data has been converted to digital data, the digital data may be further processed by a field-programmable gate array 204. The field-programmable gate array 204 may include code to process the images. The images should be processed so that 50% of the original image one 30 and image two 32 is deleted or extracted. The same side of the images should be deleted or extracted. Then, the image should be further processed so that one of the resulting images is mirrored. Lastly, the images should be placed in juxtaposition such that they appear on the same screen. Once that image data has been processed, it may optionally be further processed, depending on the operator display 102. For instance, if the operator display 102 is an analog television or monitor, the data from the field-programmable gate array 204 should be processed through a digital-to-analog converter 206.

Once the image has been fully processed, a signal is sent from the processing unit 34 to the operator display 102. As shown in FIG. 3, the operator display 102 shows a split-screen composite image comprising half of image one 104 and half of a mirrored image two 106. The operator display may be viewed by an operator that manually manipulates the apparatus of the present invention. The apparatus may be manipulated by the use of a user control 110. The user control 110 may work with a control device 108 to manipulate the positioning of the apparatus, the imaging devices of the apparatus, and/or the position of the component to be aligned. The control device 108 may be electrically, mechanically, pneumatically, or hydraulically driven. Alternatively, the apparatus or control device may be automatically manipulated by a computer program which may stored on a computer readable storage medium and executed by a processor. In addition, the control device 108 may be a combination of the aforementioned systems or another type of control altogether.

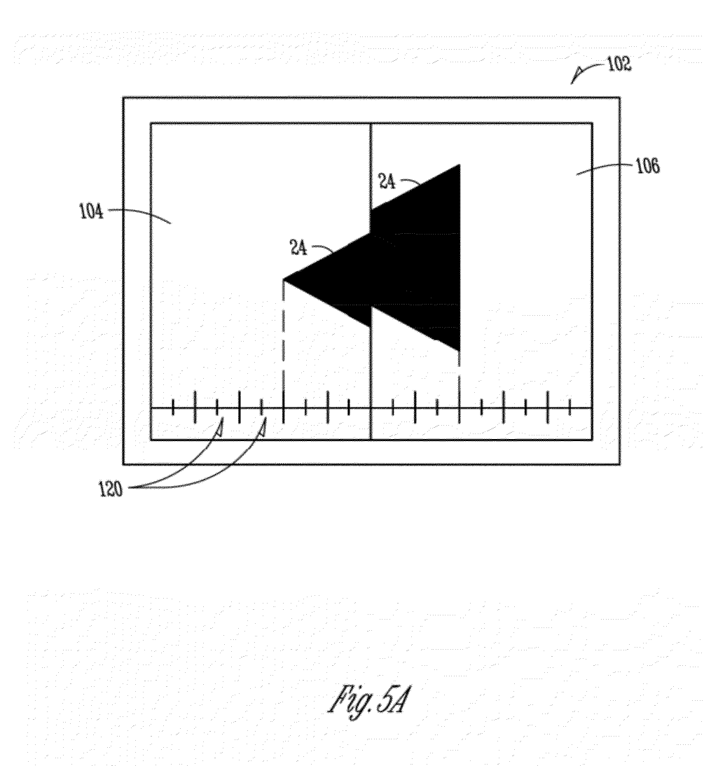

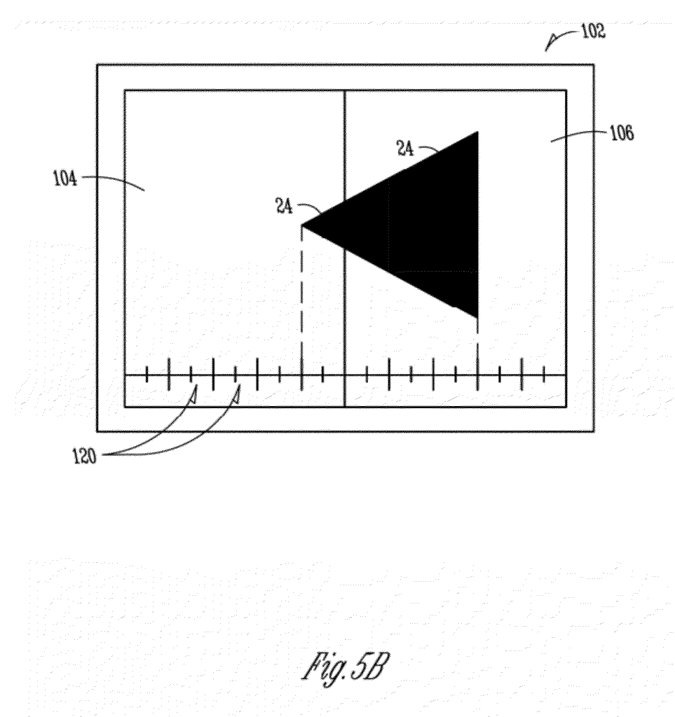

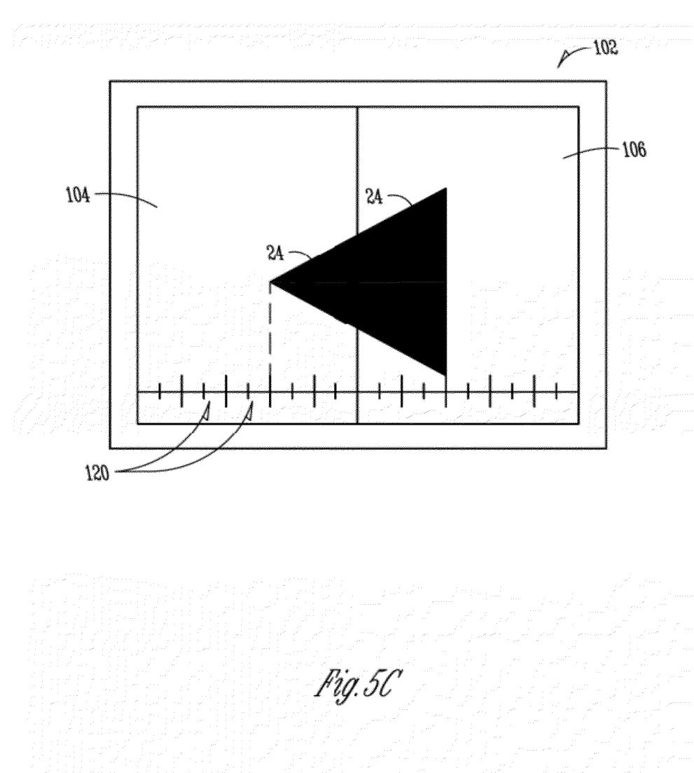

FIGS. 5a-5c are sample illustrations of the operator display 102 showing the alignment of a component with a target 24 along two axes. FIG. 5a is a perspective view of a display terminal where the component is not aligned with the target along a first axis. It is easily seen that half of image one 104 is out of alignment with half of a mirrored image two 106. In order to correct this misalignment, an operator or control system may move the component along a first axis until the halves of the images 104, 106 are aligned. Once the images are aligned along the first axis, the component must be aligned along a second axis.

FIG. 5b is a perspective view of the display terminal where the component is aligned with the target along a first axis, but not aligned with the target along a second axis. The alignment along a second axis is illustrated by the use of a scale 120 on the operator display 102. The scale 120 shows the width of the image on the screen and allows an operator to determine the extent to which the target 24 is shown on each side of the split-screen display. The target 24 will be aligned once it is shown equally on each side of the split-screen. For example, the target 24 is not aligned along a second axis in FIG. 5b, because the portion of target 24 visible in image one 104 is only two marks wide on the scale 120. The portion of target 24 visible in image two 106 is six marks long. Since the image is not shown equally on each side of the split-screen display, as shown by the scale 120, the target 24 is not aligned along a second axis. In order to correct this misalignment, an operator or control system may move the component along a second axis until the target 24 is equivalent in scale 120 as shown in the halves of the images 104, 106.

FIG. 5c is a perspective view of the display terminal where the target 24 is fully aligned with the component along two axes. The target is shown as fully aligned between the halves of images 104, 106 indicating that it is aligned with respect to a first axis. The images 104, 106 are equivalent in scale 120, as the portion of target 24 visible in image one 104 is four marks wide and the portion of target 24 visible in image two 106 is four marks long. Since the image is shown equally on each side of the split-screen display, as shown by the scale 120, the target 24 is aligned along a second axis.

A method of making such an alignment system may include several steps. First, at least two imaging devices having image planes should be provided. The first imaging device and the second imaging device should be placed in relation to a component, and adjusted such that the component is orthogonal to the center of the intersection of the imaging devices' image planes. A processing unit or multiple processing units should be connected to the first and second imaging devices. The processing unit may be connected to the constituents of this system by wire, cable, or wireless connection. Any method of connection is acceptable, as long as the data and/or signals are sent, processed, and received across the system. The processing unit should be programed to perform several functions: to extract or delete portions of a first image and a second image captured by the first and second imaging devices; to mirror one of the first image or second image; and to make a composite image of the first image and the second image. The processing unit may execute further functions, for example digital-to-analog conversion. The processing unit may be connected to a display terminal. The processing unit may include a processor and a machine readable storage medium upon which instructions are stored to perform one or more of the previously described functions.

It should be noted that the methods of the present invention may be utilized with more than two imaging devices. For example, four imaging devices may be utilized to provide four images to a single split-screen display, where two of the images are mirrored. Such a modification may provide more accurate alignment of the component with a target. In such an embodiment, the system will work in a similar manner to the embodiment previously described, as long as the imaging devices are aligned such that the component is orthogonal to the center of the fields of view of the imaging devices. The images would be decomposed to only include 25% of each image, so that the operator display will include a quadrant view. It should also be noted that two of each imaging device should be aligned in a linear fashion, along two axes for this embodiment. Such an embodiment would allow for the alignment of a component along multiple axes with or without the use of a scale.

The invention has been shown and described above with the several embodiments, and it is understood that many modifications, substitutions, and additions may be made which are within the intended spirit and scope of the invention. From the foregoing, it can be seen that the present invention accomplishes at least all of its stated objectives.

What is claimed is:

1. An apparatus for aligning a component with a target comprising:
a first imaging device having a first image plane;
a second imaging device having a second image plane;
a processing unit adapted to extract or delete portions of a first image and a second image captured by the first and second imaging devices, to mirror one of the first image or second image, and to make a composite image of the first image and the second image; and
a display terminal.

2. The apparatus of claim 1, wherein the processing unit comprises an analog-to-digital converter and a field-programmable gate array.

3. The apparatus of claim 1, wherein the first and second imaging devices are placed in linear relation to the component.

4. The apparatus of claim 1, wherein the display terminal is a television, a computer monitor, a screen, or an LCD display.

5. The apparatus of claim 1, wherein the first imaging device and the second imaging device comprise video cameras.

6. The apparatus of claim 1, wherein the first and second image planes are arranged such that the component is orthogonal to the center of an intersection of the first and second image planes.

7. A method of aligning a component with a target comprising:
placing a first imaging device having a first image plane and a second imaging device having a second image plane in relation to the component;
adjusting the first and second image planes such that the component is orthogonal to the center of the intersection of the first and second image planes;
extracting or deleting a portion of a first image and a second image captured by the first and second imaging devices;
creating a mirror image of the second image;
creating a composite image of the first image and the mirror image;
displaying the composite image as a split-screen on a display terminal;
placing the target within the first and second image planes; and
manipulating the component and imaging devices until the composite image of the target is aligned.

8. The method of claim 7, wherein the first and second imaging devices are placed in linear relation to the component.

9. The method of claim 7, wherein the portion extracted or deleted comprises 50% of the first image and 50% of the second image.

10. The method of claim 7, wherein the composite image further comprises a scale.

11. The method of claim 10, wherein the component is manipulated by aligning the target with respect to a first axis and a second axis.

12. The method of claim 11, wherein the component is aligned with respect to the first axis by aligning the composite image of the target on the split-screen.

13. The method of claim 12, wherein the component is aligned with respect to the second axis by aligning the composite image of the target to be equivalent on the scale.

14. The method of claim 7, wherein the component is manipulated manually.

15. The method of 7, wherein the component is manipulated automatically by a controller.

16. A method of making an alignment system comprising:
providing a first imaging device having a first image plane;
providing a second imaging device having a second image plane;
placing the first imaging device and the second imaging device in relation to a component;
adjusting the first and second image planes such that the component is orthogonal to the center of the intersection of the first and second image planes;
connecting a processing unit to the first and second imaging devices;
programming the processing unit to extract or delete portions of a first image and a second image captured by the first and second imaging devices;
programming the processing unit to mirror one of the first image or second image;
programming the processing unit to make a composite image of the first image and the second image; and
connecting the processing unit to a display terminal.

17. The method of claim 16, wherein the first and second imaging devices are placed in linear relation to the component.

18. The method of claim 16, wherein the processing unit is connected to the first imaging device, the second imaging device, and the display terminal by cable or wireless connection.

19. The method of claim 16, wherein the composite image further comprises a scale.

20. The method of claim 16, wherein the first imaging device and the second imaging device comprise video cameras; and wherein the display terminal is a television, a computer monitor, a screen, or an LCD display.
